(19) United States
(12) Patent Application Publication
(10) Pub. No.: US 2007/0108244 A1
(43) Pub. Date: May 17, 2007

(54) MOUNT FOR INSTALLING ACCESSORIES ON A BICYCLE

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/164,146

(22) Filed: Nov. 11, 2005

(51) Int. Cl. B62J 11/00; B62J 7/06; B62J 7/00

(52) U.S. Cl. 224/420; 224/412

(57) ABSTRACT

There is disclosed a mount for installing accessories on a proper portion of a bicycle. The mount includes a first joint connected to the proper portion of the bicycle, a second joint connected to the first joint, a rod pivotally connected to the second joint and a bar pivotally connected to the rod in order to support the accessories.

### BACKGROUND OF INVENTION

1. Field of Invention

The present invention relates to a mount for installing accessories on a bicycle.

2. Related Prior Art

Referring to FIG. 16, there is shown a conventional mount for installing accessories on a bicycle. The conventional mount includes a joint 1 for compliant contact with the handlebar of the bicycle, a strap 4 for binding the joint 1 to the handlebar, a rod 2 connected to the joint 1 and a crossbar 3 connected to the rod 2. A few problems have been encountered in using the conventional mount. Firstly, the rod 2 is secured to the joint 1 so that the former cannot rotate on the latter. The annular position of the mount on the handlebar cannot be adjusted once the strap 4. Secondly, the crossbar 3 is secured to the rod 2 so that the former cannot rotate on the latter. When not in use, the crossbar 3 still occupies a lot of space.

The present invention is therefore intended to obviate or at least alleviate the problems encountered in prior art.

### SUMMARY OF INVENTION

According to the present invention, there is disclosed a mount for installing accessories on a proper portion of a bicycle. The mount includes a first joint connected to the proper portion of the bicycle, a second joint connected to the first joint, a rod pivotally connected to the second joint and a bar pivotally connected to the rod in order to support the accessories.

An advantage of the mount of the present invention is that the rod is pivotally connected to the second joint so that the angular position of the rod on the joint can be adjusted easily.

Another advantage of the mount of the present invention is that the bar is pivotally connected to the rod so that former can conceal the latter, thus occupying only a small space.

Other objectives, advantages and novel features of the present invention will become more apparent from the following detailed description referring to the attached drawings.

### BRIEF DESCRIPTION OF DRAWINGS

The present invention will be described through illustration of two embodiments referring to the drawings.

FIG. 1 is a perspective view of a mount for installing accessories on a bicycle according to the first embodiment of the present invention.

FIG. 2 is an exploded view of the mount shown in FIG. 1.

FIG. 3 is a cross-sectional view of the mount taken along a line 3-3 in FIG. 1.

FIG. 4 is a cross-sectional view of the mount taken along a line 4-4 in FIG. 1.

FIG. 5 is a side view of the mount shown in FIG. 1.

FIG. 6 is another cross-sectional view of the mount shown in FIG. 1.

FIG. 7 is an enlarged partial view of the mount shown in FIG. 6.

FIG. 8 is a top view of the mount shown in FIG. 1.

FIG. 9 is a side view of a bicycle on which accessories are installed by means of the mount shown in FIG. 1.

FIG. 10 is a side view of the accessories in other positions than shown in FIG. 9.

FIG. 11 is a side view of the accessories in other positions than shown in FIG. 10.

FIG. 12 is a side view of the bicycle on which another accessory is installed other than shown in FIG. 11.

FIG. 13 is a perspective view of the mount in another position than shown in FIG. 1.

FIG. 14 is a perspective view of a mount for installing accessories on a bicycle according to the second embodiment of the present invention.

FIG. 15 is a perspective partial view of a bicycle on which an accessory is installed by means of the mount shown in FIG. 14.

FIG. 16 is a perspective view of a conventional mount for installing accessories on a bicycle.

### DETAILED DESCRIPTION OF EMBODIMENTS

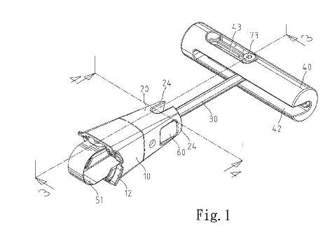

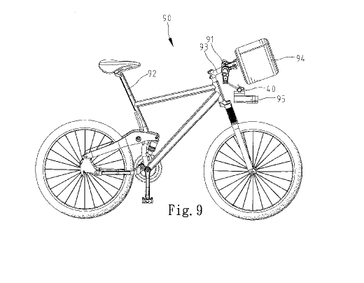

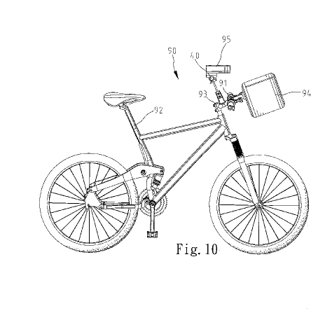

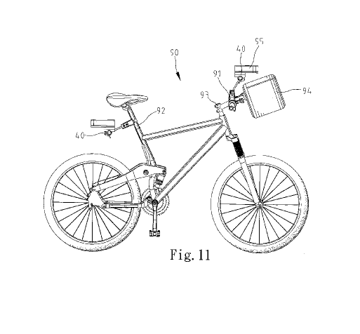

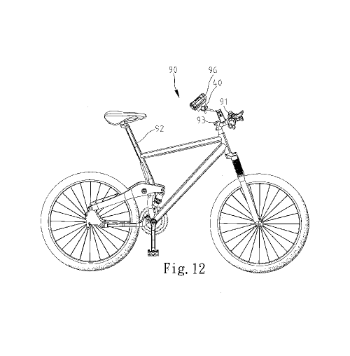

Referring to FIG. 1, according to a first embodiment of the present invention, a mount is devised for installing accessories on a bicycle 90 (FIGS. 9 through 12 and 15). The mount includes a first joint 10 for compliant contact with the bicycle 90, a second joint 20 connected to the first joint 10, a rod 30 pivotally connected to the second joint 20 and a bar 40 movably and pivotally connected to the rod 30 in order to support the accessories.

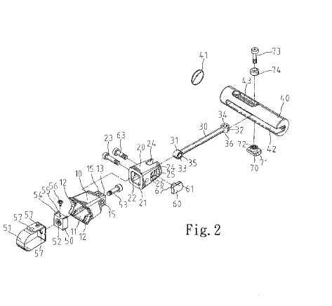

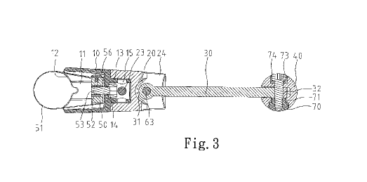

Referring to FIGS. 2 and 3, the first joint 10 is hollow, i.e., it defines a space 11 for containing a strap 51, a nut 50, and two threaded bolts 56 and 53. The strap 51, the nut 50 and the threaded bolts 56 and 53 are used for binding the first joint 10 to the bicycle 90. The first joint 10 includes an open end and a perforated end defining an aperture 14. At the open end, the first joint 10 is formed with two concave edges 12 for compliant contact with the bicycle 90. At the perforated end, the first joint 10 is formed with a neck 13 for insertion in the second joint 20. The neck 13 defines a plurality of screw holes 15.

The strap 51 defines an aperture 57 near a first end and a series of apertures 57 near a second end. The strap 51 is wound around a proper portion of the bicycle 90. Based on the size of the proper portion of the bicycle 90, the aperture 57 near the first end of the strap 51 is aligned to selective one of the apertures 57 near the second end of the strap 51.

The nut 50 defines a peripheral screw hole 55 in the bottom of one of two cavities 54 and an axial screw hole 52. The cavities 54 receive two sections of the strap 51. The threaded bolt 56 is driven in the peripheral screw hole 55 through the aligned apertures 57 so that the strap 51 is made into a loop 51 and that the loop 51 is connected to the nut 50. The threaded bolt 53 is driven in the axial screw hole 52 via the aperture 14 so that tension is loaded on the loop 51 for binding the first joint 10 to the proper portion of the bicycle 90.

The second joint 20 includes a space 21 for receiving the neck 13, a countersink hole 22 in communication with the space 21, two lugs 24 formed thereon, a non-circular cavity 25 defined in one of the lugs 24, an aperture 26 defined in the bottom of the non-circular cavity 25, a countersink hole 27 defined in the other lug 24. Together, the non-circular cavity 25 and the aperture 26 make a countersink hole.

A threaded bolt 23 is driven in one of the screw holes 15 through the countersink hole 22, thus securing the second joint 20 to the first joint 10.

The rod 30 includes two rings 31 and 32 formed at two ends. The ring 31 defines an aperture 33 and includes a plurality of teeth 35 formed on a side. The ring 32 defines an aperture 34 and includes a plurality of teeth 36 formed on a side.

There is provided a nut 60 consisting of a non-circular portion 61, a circular portion formed next to the non-circular portion 61, a plurality of teeth 62 formed on the circular portion and a screw hole defined in the circular portion.

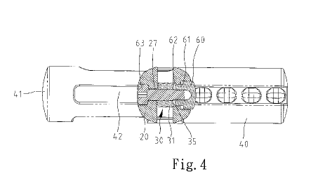

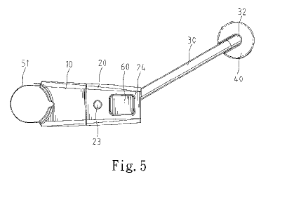

Referring to FIG. 4, the ring 31 is put between the lugs 24. The circular portion of the nut 60 is put in the aperture 26 while the non-circular portion 61 of the nut 60 is put in the non-circular cavity 26 so that the nut 60 cannot rotate on the second joint 20. The teeth 62 engage with the teeth 35, thus retaining the rod 30 in selective one of various angular positions on the second joint 20 such as shown in FIG. 5. A threaded bolt 63 is driven in the screw hole of the nut 60 through the countersink hole 27, thus ensuring the engagement of the teeth 62 with the teeth 35.

The bar 40 defines a groove 42 and two slots 43 in communication with the groove 42. The slots 43 are like countersink holes. A tag 41 is attached to the bar 40. Words and patterns can be printed, molded or engraved on the tag 41.

There is provided a nut 70. The nut 70 is identical to the nut 60. That is, the nut 70 includes a non-circular portion 71, a circular portion, a plurality of teeth 72 and a screw hole.

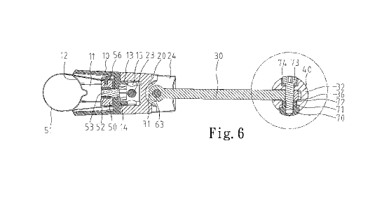

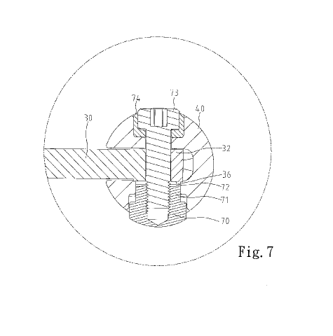

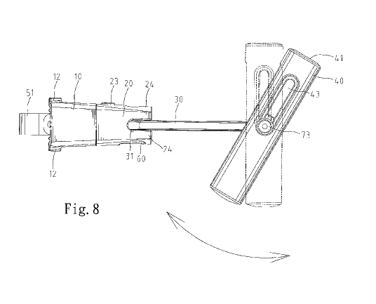

Referring to FIGS. 6 and 7, the ring 32 is put in the groove 42. The nut 70 is put in one of the slots 43 so that the nut 70 cannot rotate on the bar 40. The teeth 72 engage with the teeth 36, thus retaining the bar 40 in selective one of various angular positions on the rod 30 such as shown in FIG. 8. A threaded bolt 73 is driven in the screw hole of the nut 70 through the other slot 43, thus ensuring the engagement of the teeth 72 with the teeth 36. A washer 74 may be provided between the head of the threaded bolt 73 and the bar 40. The slots 43 allow the movement of the bar 40 on the rod 30.

Referring to FIGS. 9 through 12, the bicycle 90 includes a seat post 92, a handlebar 91 and a tube 93 for connecting the handlebar 91 to a stem. A box 94 is put on the handlebar 91. A headlight 95 is installed on the mount installed on the tube 93. The headlight 95 can be put in various positions relative to the box 94. Should both installed on the handlebar 91, the box 94 and the headlight 95 would be crowded and interfere with each other.

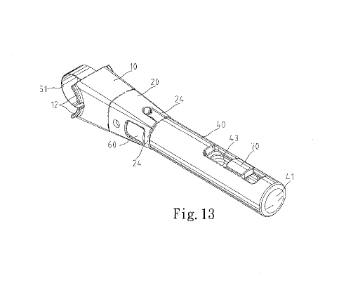

Referring to FIG. 13, the mount is retracted.

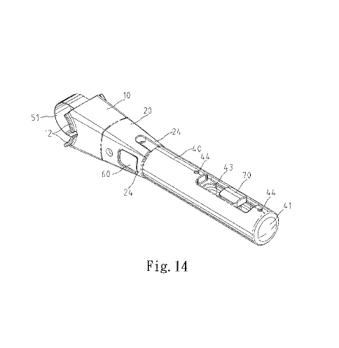

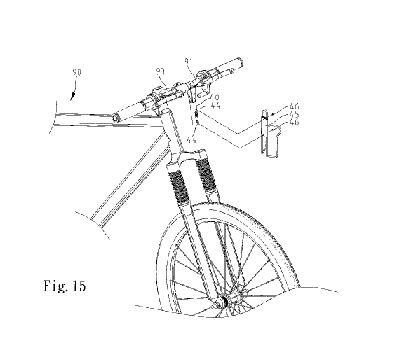

FIGS. 14 and 15 show a mount according to a second embodiment of the present invention. The second embodiment is identical to the first embodiment except including two screw holes 44 in addition. Two threaded bolts 46 can be driven in the screw holes 44 through a holder 45 for holding a bottle.

The mount of the present invention exhibits several advantages. Firstly, the rod 30 is pivotally connected to the second joint 20. The angular position of the rod 30 on the joint 20 can be adjusted easily. Secondly, the bar 40 is pivotally connected to the rod 30 so that former can conceal the latter, thus occupying only a small space.

The present invention has been described through the illustration of the embodiments. Those skilled in the art can derive variations from the embodiments without departing from the scope of the present invention. Therefore, the embodiments shall not limit the scope of the present invention defined in the claims.

What is claimed is:

1. A mount for installing accessories on a proper portion of a bicycle, the mount comprising:
a first joint connected to the proper portion of the bicycle;
a second joint connected to the first joint;
a rod pivotally connected to the second joint; and
a bar pivotally connected to the rod in order to support the accessories.

2. The mount according to claim 1 wherein the bar defines a groove for receiving the rod.

3. The mount according to claim 2 comprising a threaded bolt and a nut engaged with the threaded bolt, wherein the bar defines two openings in communication with the groove in order to receive the head of the threaded bolt and the nut, wherein the rod comprises a ring put in the groove in order to receive the threaded bolt.

4. The mount according to claim 3 wherein the nut is non-circular, wherein the related one of the openings is non-circular so that the nut cannot rotate on the bar.

5. The mount according to claim 4 wherein the nut comprises a plurality of teeth formed thereon, wherein the ring is formed with a plurality of teeth engaged with teeth of the nut, thus retaining the bar in selective one of various angular positions on the rod.

6. The mount according to claim 3 wherein the openings are slots, thus allowing the movement of the bar on the rod.

7. The mount according to claim 1 wherein the second joint comprises two lugs between which the rod is put and to which the rod is pivotally connected.

8. The mount according to claim 7 comprising a threaded bolt and a nut engaged with the threaded bolt, wherein one of the lugs defines a countersink hole for receiving the head of the threaded bolt, wherein the other lug defines a countersink hole for receiving the nut, wherein the rod comprises a ring put between the lugs in order to receive the threaded bolt.

9. The mount according to claim 8 wherein the nut is non-circular, wherein the countersink hole of the related one of the lugs is non-circular so that the nut cannot rotate on the second joint.

10. The mount according to claim 9 wherein the nut comprises a plurality of teeth formed thereon, wherein the ring is formed with a plurality of teeth engaged with teeth of the nut, thus retaining the rod in selective one of various angular positions on the second joint.

11. The mount according to claim 3 wherein the openings are slots, thus allowing the movement of the bar on the rod.

12. The mount according to claim 1 wherein the first joint comprises a neck, wherein the second joint defines a space for receiving the neck.

13. The mount according to claim 12 comprising a threaded bolt, wherein the first joint comprises a plurality of screw holes defined in the neck, wherein the second joint defines a countersink hole through which the threaded bolt is driven in selective one of the screw holes in order to keep the second joint in selective one of various angular positions on the first joint.

14. The mount according to claim 1 comprising a strap for binding the first joint to the proper portion of the bicycle.

15. The mount according to claim 14 wherein the strap is made into a loop wound around the proper portion of the bicycle.

16. The mount according to claim 15 comprising a nut and a threaded bolt driven in the nut through two sections of the strap, thus solidifying the loop.

17. The mount according to claim 16 wherein the strap defines an aperture near a first end and a plurality of aperture near a second end, wherein the threaded bolt is driven in the aperture near the first end of the strap and selective one of the apertures near the second end of the strap, thus keeping the loop in selective one of various sizes.

18. The mount according to claim 15 comprising a nut and a threaded bolt driven in the nut through the loop and the first joint, thus loading tension onto the loop.

19. The mount according to claim 18 wherein the nut defines two cavities for receiving two sections of the loop.

20. The mount according to claim 18 wherein the first joint defines a space for receiving the nut, the threaded bolt and a section of the loop.

21. The mount according to claim 1 wherein the first joint comprises two concave edges in compliant contact with the proper portion of the bicycle.

22. The mount according to claim 1 comprising a tag attached to the bar.
